(19) United States
(12) Patent Application Publication
(10) Pub. No.: US 2018/0091566 A1
(43) Pub. Date: Mar. 29, 2018

(54) APPARATUS, METHOD, AND PROGRAM PRODUCT FOR CONTENT NOTIFICATION

(71) Applicant: LENOVO (Singapore) PTE. LTD., New Tech Park (SG)

(72) Inventors: John Carl Mese, Cary, NC (US); Nathan J. Peterson, Oxford, NC (US); Russell Speight VanBlon, Raleigh, NC (US); Arnold S. Weksler, Raleigh, NC (US)

(21) Appl. No.: 15/280,816

(22) Filed: Sep. 29, 2016

(51) Int. Cl. H04L 29/06

(52) U.S. Cl. CPC H04L 65/4015; G06F 3/14

(57) ABSTRACT

Apparatuses, methods, and program products are disclosed for content collaboration. One apparatus includes a processor, and a memory that stores code executable by the processor. The code is executable by the processor to receive content at an application from a first user of the application. The code is executable by the processor to detect an association between the content and a second user of the application. The content excludes a picture showing a first image of the second user if the detected association is between the picture showing the first image of the second user and a second image of the second user. The code is executable by the processor to determine to provide notification of the content to the second user in response to detecting the association between the content and the second user.

### BACKGROUND

### Field

The subject matter disclosed herein relates to content and more particularly relates to notification of content.

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for sharing content. Content notifications of shared content may not be provided to some users.

### BRIEF SUMMARY

An apparatus for content collaboration is disclosed. A method and computer program product also perform the functions of the apparatus. In one embodiment, the apparatus includes a processor, and a memory that stores code executable by the processor. The code, in various embodiments, is executable by the processor to receive content at an application from a first user of the application. In a further embodiment, the code is executable by the processor to detect an association between the content and a second user of the application. In such an embodiment, the content excludes a picture showing a first image of the second user if the detected association is between the picture showing the first image of the second user and a second image of the second user. The code, in some embodiments, is executable by the processor to determine to provide notification of the content to the second user in response to detecting the association between the content and the second user.

In some embodiments, the content includes information selected from the group including a picture, a video, audio, a calendar, a location, an email, a comment, a text message, a post, a link, a website, and a blog. In one embodiment, the code executable by the processor detects the association between the content and the second user of the application by analyzing information corresponding to the second user and detecting that the information relates to the content.

In another embodiment, the information corresponding to the second user includes information selected from the group including a setting, a preference, a picture, a video, audio, a calendar, a location, an email, a comment, a text message, a post, a link, a website, and a blog. In some embodiments, the code executable by the processor indicates to the first user the association between the content and the second user.

A method for content collaboration, in one embodiment, includes receiving, by use of a processor, content at an application from a first user of the application. In some embodiments, the method includes detecting an association between the content and a second user of the application. In such embodiments, the content excludes a picture showing a first image of the second user if the detected association is between the picture showing the first image of the second user and a second image of the second user. In a further embodiment, the method includes determining to provide notification of the content to the second user in response to detecting the association between the content and the second user.

In some embodiments, receiving the content at the application includes receiving information selected from the group including a picture, a video, audio, a calendar, a location, an email, a comment, a text message, a post, a link, a website, and a blog. In various embodiments, receiving the content at the application includes receiving the content at a social media application. In one embodiment, detecting the association between the content and the second user of the application includes analyzing information corresponding to the second user and detecting that the information relates to the content.

In some embodiments, analyzing the information corresponding to the second user includes analyzing information selected from the group including a setting, a preference, a picture, a video, audio, a calendar, a location, an email, a comment, a text message, a post, a link, a website, and a blog. In certain embodiments, the method includes indicating to the first user the association between the content and the second user. In various embodiments, the method includes enabling the first user to determine to provide the notification of the content to the second user. In one embodiment, the method includes providing the notification of the content to the second user. In some embodiments, providing the notification of the content to the second user includes linking the content to the second user. In various embodiments, providing the notification of the content to the second user includes tagging the content as related to the second user. In certain embodiments, providing the notification of the content to the second user includes sharing the content with the second user.

In one embodiment, a program product includes a computer readable storage medium that stores code executable by a processor. The executable code, in certain embodiments, includes code to perform receiving content at an application from a first user of the application. In a further embodiment, the executable code includes code to perform detecting an association between the content and a second user of the application. In such an embodiment, the content excludes a picture showing a first image of the second user if the detected association is between the picture showing the first image of the second user and a second image of the second user. The executable code, in some embodiments, includes code to perform determining to provide notification of the content to the second user in response to detecting the association between the content and the second user.

In certain embodiments, the executable code includes code to perform indicating to the first user the association between the content and the second user. In some embodiments, the executable code includes code to perform enabling the first user to determine to provide the notification of the content to the second user. In various embodiments, the executable code includes code to perform providing the notification of the content to the second user.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for content collaboration;

FIG. 2 is a schematic block diagram illustrating one embodiment of an apparatus including an information handling device;

FIG. 3 is a schematic block diagram illustrating one embodiment of an apparatus including a content collaboration module;

FIG. 4 is a schematic block diagram illustrating another embodiment of an apparatus including a content collaboration module;

FIG. 5 is a schematic flow chart diagram illustrating an embodiment of a method for content collaboration; and

FIG. 6 is a schematic flow chart diagram illustrating another embodiment of a method for content collaboration.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

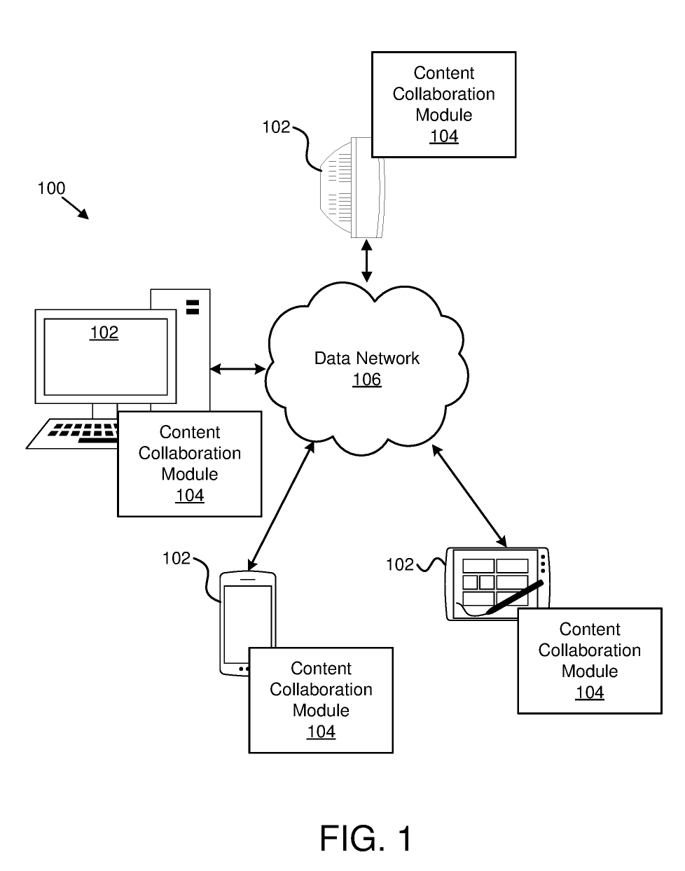

FIG. 1 depicts one embodiment of a system 100 for content collaboration. In one embodiment, the system 100 includes information handling devices 102, content collaboration modules 104, and data networks 106. Even though a specific number of information handling devices 102, content collaboration modules 104, and data networks 106 are depicted in FIG. 1, one of skill in the art will recognize that any number of information handling devices 102, content collaboration modules 104, and data networks 106 may be included in the system 100.

In one embodiment, the information handling devices 102 include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), streaming devices, or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the content collaboration module 104. In certain embodiments, the content collaboration module 104 may receive content at an application from a first user of the application. The content collaboration module 104 may detect an association between the content and a second user of the application. In some embodiments, the content excludes a picture showing a first image of the second user if the detected association is between the picture showing the first image of the second user and a second image of the second user. The content collaboration module 104 may also determine to provide notification of the content to the second user in response to detecting the association between the content and the second user. In this manner, the content collaboration module 104 may be used for content collaboration.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

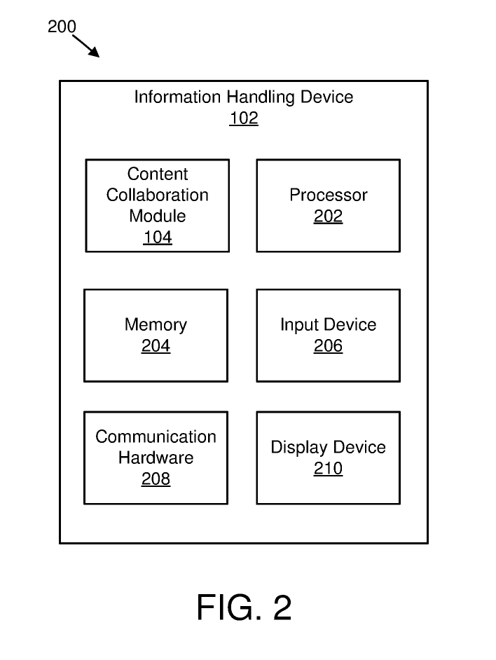

FIG. 2 depicts one embodiment of an apparatus 200 that may be used for content collaboration. The apparatus 200 includes one embodiment of the information handling device 102. Furthermore, the information handling device 102 may include the content collaboration module 104, a processor 202, a memory 204, an input device 206, communication hardware 208, and a display device 210. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the content collaboration module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores data relating to content collaboration. In some embodiments, the memory 204 also stores program code and related data, such as an operating system or other controller algorithms operating on the information handling device 102.

The information handling device 102 may use the content collaboration module 104 for content collaboration. As may be appreciated, the content collaboration module 104 may include computer hardware, computer software, or a combination of both computer hardware and computer software. For example, the content collaboration module 104 may include circuitry, or a processor, used to detect an association between content and a second user of the application. As another example, the content collaboration module 104 may include computer program code that determines to provide notification of the content to the second user in response to detecting the association between the content and the second user.

The input device 206, in one embodiment, may include any known computer input device including a touch panel, a button, a keyboard, a stylus, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon content notification.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the content collaboration module 104.

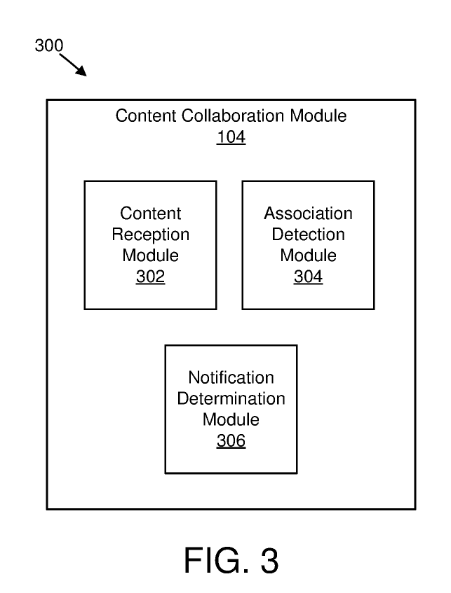

FIG. 3 depicts a schematic block diagram illustrating one embodiment of an apparatus 300 that includes one embodiment of the content collaboration module 104. Furthermore, the content collaboration module 104 includes a content reception module 302, an association detection module 304, and a notification determination module 306.

The content reception module 302 receives content at an application from a first user of the application. In some embodiments, the content may include any information and/or data provided to, uploaded to, typed into, inserted into, and/or added to the application. For example, the content may include a picture, a video, audio, a calendar (e.g., calendar entry, monthly calendar, annual calendar, etc.), a location (e.g., address, global positioning system coordinates, name of a place—school, business, house, etc.), an email (e.g., contents of a sent and/or received email, an email address, etc.), a comment, a text message, a post, a link (e.g., a link to a website, a link to a document, etc.), a website (e.g., page from a website, website address, complete website, etc.), and/or a blog (e.g., contents of a blog, a link to a blog, a name of a blog, etc.).

In various embodiments, the application may be any suitable application, such as a sharing application, a social media application, an interactive application, a multi-user application, and so forth. In some embodiments, the application may receive the content by the first user actively providing the content to the application, the first user giving the application permission to retrieve the content, the application accessing and/or retrieving the content, and/or the application dynamically obtaining the content. In certain embodiments, the first user may voluntarily subscribe to provide the application with access to content such as profile information, electronic device interactive information (e.g., Google Now™), location information, calendar information, email history, social media interactions, and so forth.

In some embodiments, the association detection module 304 detects an association between the content and a second user of the application. In certain embodiments, the content excludes (e.g., does not include) a picture showing a first image of the second user if the detected association is between the picture showing the first image of the second user and a second image of the second user. For example, the may exclude content of a picture (e.g., photograph, image, video, etc.) showing a first image of the second user if a detected association is between the picture showing the first image of the second user and a second image of the second user. Accordingly, the content that excludes the picture may inhibit and/or exclude the association detection module 304 from identifying the image of the second user in the content. As may be appreciated, the second user of the application may be different from the first user of the application.

Detecting the association between the content and the second user of the application may include analyzing information corresponding to the second user and detecting that the information relates to the content. In one embodiment, analyzing the information corresponding to the second user includes analyzing information including a setting, a preference, a picture, a video, audio, a calendar, a location, an email, a comment, a text message, a post, a link, a website, and/or a blog. As may be appreciated, the information corresponding to the second user may be obtained from the second user in ways similar to the application receiving the content. For example, in certain embodiments, the second user may voluntarily subscribe to provide the application with access to information such as profile information, electronic device interactive information, location information, calendar information, email history, social media interactions, and so forth.

In some embodiments, the content from the first user may be converted by the application into first textual information (or otherwise searchable information) and/or the information corresponding to the second user may be converted by the application into second textual information (or otherwise searchable information). The association detection module 304 may compare the first textual information to the second textual information to determine whether the second user has an association with (e.g., interest in) the first textual information.

In one embodiment, the notification determination module 306 determines whether to provide notification of the content to the second user in response to detecting the association between the content and the second user. For example, in response to detecting that there is an association between the content and the second user, the notification determination module 306 may provide notification of the content to the second user. As another example, in response to detecting that there is not an association between the content and the second user, the notification determination module 306 may not provide notification of the content to the second user.

In some embodiments, the content collaboration module 104 may indicate to the first user the association between the content and the second user. In various embodiments, the content collaboration module 104 may enable the first user to determine whether to provide the notification of the content to the second user. In various embodiments, the content collaboration module 104 may provide the notification of the content to the second user. For example, the content collaboration module 104 may link the content to the second user (e.g., inform the second user of the content by email, inform the second user of the content on a portion of the application corresponding to the second user, etc.), tag the content as related to the second user (e.g., inform the second user of the content by email, inform the second user of the content on a portion of the application corresponding to the second user, etc.), and/or share the content with the second user (e.g., send the second user the content by email, place the content on a portion of the application corresponding to the second user, etc.).

In one example, the content collaboration module 104 may receive a picture of the first user's son with a Lego® set he built (e.g., content from a first user) at an application. After uploading the picture to the application, the application may identify one or more other users that are associated with the first user (e.g., in a same group, friends, associates, family members, etc.) that have an interest in Lego® related items. The application may do this by first identifying the Lego® set in the picture, then identifying users associated with the first user that have an interest in Lego® related items based on prior conversations, prior posts, etc. The application may suggest that the picture be shared with the other users that have an interest in the Lego® related items and/or may enable the first user to tag, share, and/or link the picture to the other users.

In another example, the content collaboration module 104 may detect that the first user attended a monster truck show (e.g., specific location) at a time a picture is taken. The picture is uploaded to an application. The application may identify one or more other users associated with the first user that attended the monster truck show. The application may suggest that the picture be shared with the other users that attended the monster truck show and/or may enable the first user to tag, share, and/or link the picture to the other users.

In a further example, the content collaboration module 104 may detect that the first user visits someone's house and takes a picture. The application may identify one or more other users associated with the first user that are located at the house at the same time. The application may suggest that the other users be tagged in the picture based on their location at the time the picture was taken.

In an additional example, the content collaboration module 104 may detect that the first user visits a college campus and the application receives content related to the visit to the college campus. The application may identify one or more other users associated with the first user that attended the college and/or have posted information about the college. The application may suggest that the first user tag, share, and/or link the content to the other users.

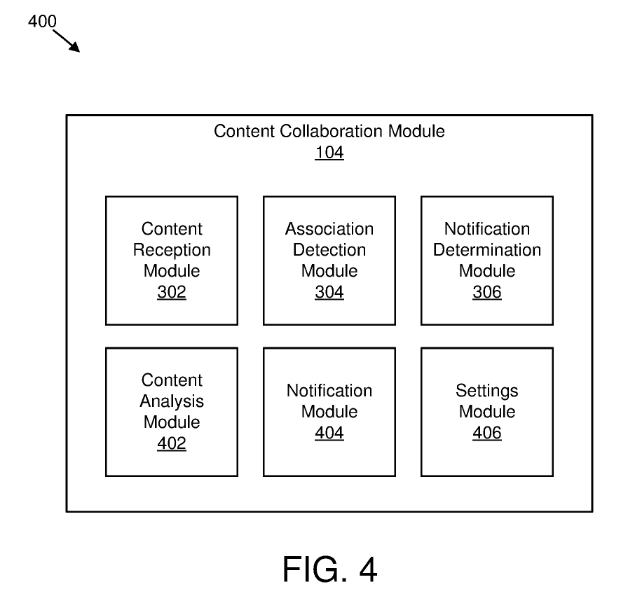

FIG. 4 is a schematic block diagram illustrating another embodiment of an apparatus 400 that includes one embodiment of the content collaboration module 104. Furthermore, the content collaboration module 104 includes one embodiment of the content reception module 302, the association detection module 304, and the notification determination module 306, that may be substantially similar to the content reception module 302, the association detection module 304, and the notification determination module 306 described in relation to FIG. 3. The content collaboration module 104 also includes a content analysis module 402, a notification module 404, and a settings module 406.

The content analysis module 402 may analyze information corresponding to the second user. In some embodiments, analyzing information corresponding to the second user includes analyzing information such as a setting, a preference, a picture, a video, audio, a calendar, a location, an email, a comment, a text message, a post, a link, a website, and/or a blog. As may be appreciated, the information corresponding to the second user may be obtained from the second user in ways similar to the application receiving the content. For example, in certain embodiments, the second user may voluntarily subscribe to provide the application with access to information such as profile information, electronic device interactive information, location information, calendar information, email history, social media interactions, and so forth.

In some embodiments, the content analysis module 402 may convert the content from the first user into first textual information (or otherwise searchable information) and/or the information corresponding to the second user into second textual information (or otherwise searchable information). The content analysis module 402 may compare the first textual information to the second textual information to determine whether the second user has an association with (e.g., interest in) the first textual information.

In some embodiments, the notification module 404 indicates to the first user the association between the content and the second user. The notification module 404 may immediately indicate the association shortly after the content is received by the content collaboration module 104 (e.g., on screen notification) and/or the notification module 404 may indicate the association at a future time (e.g., via email, etc.). In various embodiments, the notification module 404 may provide the notification of the content to the second user by linking the content to the second user, tagging the content as related to the second user, and/or sharing the content with the second user. The notification module 404 may provide the notification of the content to the second user in real-time (e.g., on screen notification) and/or in a delayed manner (e.g., via email, etc.).

In one embodiment, the settings module 406 enabling the first user to determine to provide the notification of the content to the second user. In certain embodiments, the settings module 406 may facilitate notification preapproval. In some embodiments, the settings module 406 may facilitate approval prior to each notification.

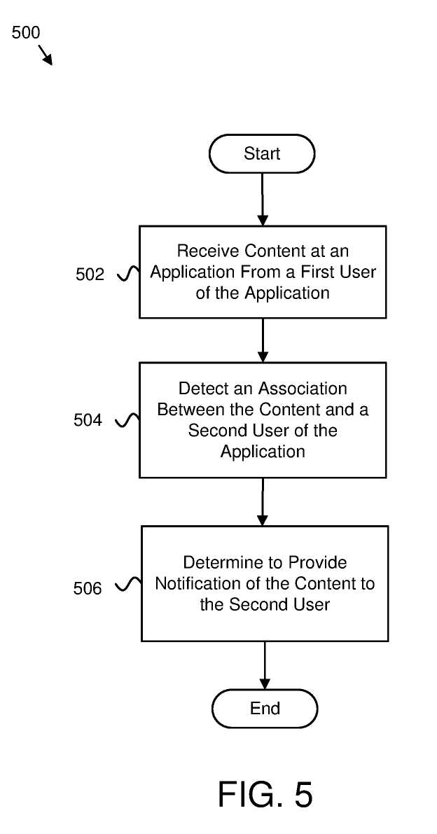

FIG. 5 is a schematic flow chart diagram illustrating an embodiment of a method 500 for content collaboration. In some embodiments, the method 500 is performed by an apparatus, such as the information handling device 102. In other embodiments, the method 500 may be performed by a module, such as the content collaboration module 104. In certain embodiments, the method 500 may be performed by a processor executing program code, for example, a microcontroller, a microprocessor, a CPU, a GPU, an auxiliary processing unit, a FPGA, or the like.

The method 500 may include receiving 502 content at an application from a first user of the application. In certain embodiments, the content reception module 302 may receive 502 the content at the application from the first user of the application. In some embodiments, receiving 502 the content at the application includes receiving information selected from a group including a picture, a video, audio, a calendar, a location, an email, a comment, a text message, a post, a link, a website, and a blog. In various embodiments, receiving 502 the content at the application includes receiving the content at a social media application.

The method 500 may also include detecting 504 an association between the content and a second user of the application. In such an embodiment, the content may exclude a picture showing an image of the second user. In certain embodiments, the association detection module 504 may detect 504 the association between the content and the second user of the application. In one embodiment, detecting 504 the association between the content and the second user of the application includes analyzing information corresponding to the second user and detecting that the information relates to the content. In some embodiments, analyzing the information corresponding to the second user includes analyzing information selected from a group including a setting, a preference, a picture, a video, audio, a calendar, a location, an email, a comment, a text message, a post, a link, a website, and a blog.

The method 500 may determine 506 to provide notification of the content to the second user in response to detecting the association between the content and the second user, and the method 500 may end. In one embodiment, the method 500 may include indicating to the first user the association between the content and the second user. In some embodiments, the method 500 may include enabling the first user to determine to provide the notification of the content to the second user. In various embodiments, the method 500 may include providing the notification of the content to the second user. In such embodiments, the method 500 may include linking the content to the second user, tagging the content as related to the second user, and/or sharing the content with the second user.

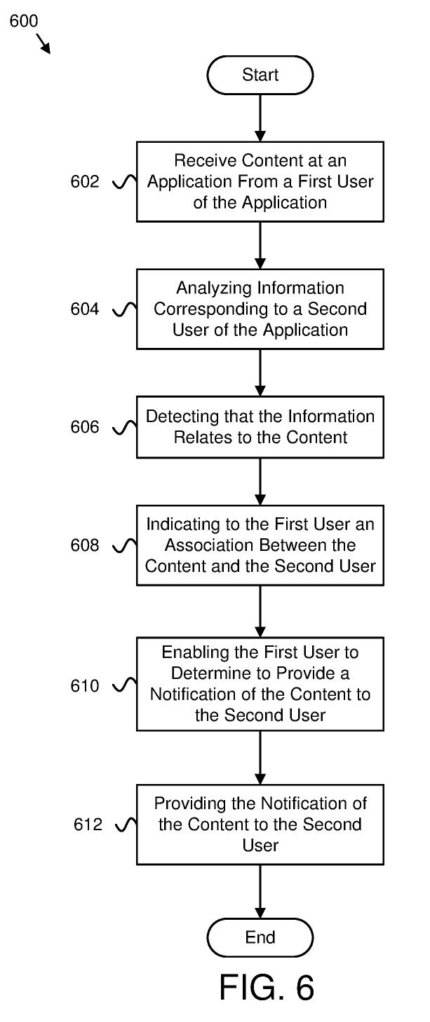

FIG. 6 is a schematic flow chart diagram illustrating another embodiment of a method 600 for content collaboration. In some embodiments, the method 600 is performed by an apparatus, such as the information handling device 102. In other embodiments, the method 600 may be performed by a module, such as the content collaboration module 104. In certain embodiments, the method 600 may be performed by a processor executing program code, for example, a microcontroller, a microprocessor, a CPU, a GPU, an auxiliary processing unit, a FPGA, or the like.

The method 600 may include receiving 602 content at an application from a first user of the application. In certain embodiments, the content reception module 302 may receive 602 the content at the application from the first user of the application. In some embodiments, receiving 602 the content at the application includes receiving information selected from a group including a picture, a video, audio, a calendar, a location, an email, a comment, a text message, a post, a link, a website, and a blog. In various embodiments, receiving 602 the content at the application includes receiving the content at a social media application.

The method 600 may also include analyzing 604 information corresponding to a second user of the application. In certain embodiments, the content analysis module 402 may analyze 604 the information corresponding to the second user of the application. In some embodiments, analyzing 604 the information corresponding to the second user includes analyzing information selected from a group including a setting, a preference, a picture, a video, audio, a calendar, a location, an email, a comment, a text message, a post, a link, a website, and a blog.

The method 600 may detect 606 that the information relates to the content. In one embodiment, the association detection module 304 may detect 606 that the information relates to the content.

The method 600 may indicate 608 to the first user an association between the content and the second user. In one embodiment, the notification module 404 may indicate 608 to the first user an association between the content and the second user.

The method 600 may enable 610 the first user to determine to provide a notification of the content to the second user. In one embodiment, the setting module 406 may enable 610 the first user to determine to provide a notification of the content to the second user.

The method 600 may provide 612 the notification of the content to the second user, and the method 600 may end. In one embodiment, the notification module 404 may provide 612 the notification of the content to the second user.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
receive content at an application from a first user of the application;
detect an association between the content and a second user of the application, wherein the content excludes a picture showing a first image of the second user if the detected association is between the picture showing the first image of the second user and a second image of the second user; and
determine to provide notification of the content to the second user in response to detecting the association between the content and the second user.

2. The apparatus of claim 1, wherein the content comprises information selected from the group consisting of a picture, a video, audio, a calendar, a location, an email, a comment, a text message, a post, a link, a website, and a blog.

3. The apparatus of claim 1, wherein the code executable by the processor detects the association between the content and the second user of the application by analyzing information corresponding to the second user and detecting that the information relates to the content.

4. The apparatus of claim 1, wherein the information corresponding to the second user comprises information selected from the group consisting of a setting, a preference, a picture, a video, audio, a calendar, a location, an email, a comment, a text message, a post, a link, a website, and a blog.

5. The apparatus of claim 1, wherein the code executable by the processor indicates to the first user the association between the content and the second user.

6. A method comprising:
receiving, by use of a processor, content at an application from a first user of the application;
detecting an association between the content and a second user of the application, wherein the content excludes a picture showing a first image of the second user if the detected association is between the picture showing the first image of the second user and a second image of the second user; and
determining to provide notification of the content to the second user in response to detecting the association between the content and the second user.

7. The method of claim 6, wherein receiving the content at the application comprises receiving information selected from the group consisting of a picture, a video, audio, a calendar, a location, an email, a comment, a text message, a post, a link, a website, and a blog.

8. The method of claim 6, wherein receiving the content at the application comprises receiving the content at a social media application.

9. The method of claim 6, wherein detecting the association between the content and the second user of the application comprises analyzing information corresponding to the second user and detecting that the information relates to the content.

10. The method of claim 9, wherein analyzing the information corresponding to the second user comprises analyzing information selected from the group consisting of a setting, a preference, a picture, a video, audio, a calendar, a location, an email, a comment, a text message, a post, a link, a website, and a blog.

11. The method of claim 6, further comprising indicating to the first user the association between the content and the second user.

12. The method of claim 6, further comprising enabling the first user to determine to provide the notification of the content to the second user.

13. The method of claim 6, further comprising providing the notification of the content to the second user.

14. The method of claim 13, wherein providing the notification of the content to the second user further comprises linking the content to the second user.

15. The method of claim 13, wherein providing the notification of the content to the second user further comprises tagging the content as related to the second user.

16. The method of claim 13, wherein providing the notification of the content to the second user further comprises sharing the content with the second user.

17. A program product comprising a computer readable storage medium that stores code executable by a processor, the executable code comprising code to perform:
receiving content at an application from a first user of the application;
detecting an association between the content and a second user of the application, wherein the content excludes a picture showing a first image of the second user if the detected association is between the picture showing the first image of the second user and a second image of the second user; and
determining to provide notification of the content to the second user in response to detecting the association between the content and the second user.

18. The program product of claim 17, wherein the executable code further comprises code to perform indicating to the first user the association between the content and the second user.

19. The program product of claim 17, wherein the executable code further comprises code to perform enabling the first user to determine to provide the notification of the content to the second user.

20. The program product of claim 17, wherein the executable code further comprises code to perform providing the notification of the content to the second user.
